(19) United States
(12) Patent Application Publication
(10) Pub. No.: US 2011/0211292 A1
(43) Pub. Date: Sep. 1, 2011

(54) Electric Fence Energiser

(75) Inventor: George William Tyler, Hamilton (NZ)

(73) Assignee: GALLAGHER GROUP LIMITED, Hamilton (NZ)

(21) Appl. No.: 13/128,368

(22) PCT Filed: Nov. 13, 2009
(86) PCT No.: PCT/NZ2009/000252

§ 371 Date: May 9, 2011

(30) Foreign Application Priority Data
Nov. 13, 2008 (NZ) 572826

(51) Int. Cl. G03G 15/02

(52) U.S. Cl. 361/225

(57) ABSTRACT

A method of operating an electric fence energiser, including the steps of: storing energy in an energy storage element, and transferring energy from the energy storage element to an inductive element, the method characterised by the steps of using a rectifying element to prevent the transfer of energy from the inductive element into a load on the output of the energiser while the transfer of energy from the energy storage element to the inductive element occurs, and releasing the energy held by the inductive element once an energy threshold on the inductive element has been reached.

### TECHNICAL FIELD

This invention relates to improvements and modifications to electric fence energisers.

### BACKGROUND ART

Electric fence energisers have been used for over 50 years in the control of animals and security devices. Over this time the basic circuit topology has not changed substantially. Generally, a capacitor is charged to a pre-selected voltage by a power supply. The capacitor is then discharged through a transformer to step up the voltage, and onto an electric fence.

Traditionally, the power efficiency of energisers using this topology has been determined by the transformer, particularly the magnetic coupling, core losses and the winding losses of the transformer. Attempts to improve efficiency have therefore focused on the design of the transformer itself.

A significant disadvantage of this topology is the effect that variation in the load provided by the fence has on the efficiency of the system. Where the load changes significantly from a predetermined optimum value, the energy that is not transferred to the load from the energiser is dissipated in the form of heat—in the transformer or other resistive components within the circuitry.

As well as being inefficient, this dissipation can result in overheating issues, especially for high-powered energisers rated at over five joules.

The load applied by an electric fence system to the output of an energiser can vary greatly—from near zero ohms when a short circuit is in place, to near infinity when there is no connection to the output. As a result, effectively all designs based on the selection of a single “optimum” load will suffer from these inefficiencies.

Numerous efforts have been made to overcome these problems.

NZ 240641 describes an electric fence energiser where the load on the output of the energiser is detected and the level of charge stored by a storage capacitor is adjusted accordingly. NZ 509061 uses effectively the same technique, but achieves the desired stored charge by switching in or out a number of capacitors to provide an overall capacitance of the desired level.

NZ 272112 provides an energiser which includes a resonant circuit formed by including an inductor in series with the switch controlling the charging of the main storage capacitor, and an additional capacitor which is placed in parallel with the primary winding of the output transformer. This facilitates the control of the output energy by adjusting the width of the pulse. A significant issue with this technique can be that the additional capacitor must have similar current and voltage ratings to the main storage capacitor; potentially adding a significant cost to the topology, and also influencing the size and cost of the output transformer.

A major issue with some of the proposed solutions discussed above is that in situations where there is a light load on the output of the energiser, the output transformer core goes into saturation mode. This results in decreased efficiency and associated overheating problems.

NZ 535719 implements a control scheme using a semiconductor switching device such as an IGBT or MOSFET that may be switched in order to control the output energy supplied to the load of the energiser. The level of energy supplied is determined by load sensing on the output in conjunction with software. The high cost of the semiconductor devices makes it unattractive for commercialisation, as does the reliance on software and other active electronics for the safe operation of the energiser.

An improved energiser which can account for variation of the load on its output would be preferred. Ideally, such a design would utilise a minimum number of components in the interest of size and cost savings. Additionally, it would be preferable if such components were passive in order to increase the reliability of the energiser.

It would also be an advantage if energy not used in providing a pulse to the electric fence could be recovered rather than being dissipated in the form of heat.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to one aspect of the present invention there is provided a method of operating an electric fence energiser, including the steps of:
i. storing energy in an energy storage element, and
ii. transferring energy from the energy storage element to an inductive element,
   characterised by the steps of
iii. using a rectifying element to prevent the transfer of energy from the inductive element into a load on the output of the energiser while the transfer of energy from the energy storage element to the inductive element occurs, and
iv. releasing the energy held by the inductive element once an energy threshold on the inductive element has been reached.

According to another aspect of the present invention, there is provided a method as described above, including the step of:
v. storing the energy released by the inductive element and not absorbed by the load in the energy storage element.

According to another aspect of the present invention there is provided an electric fence energiser having an output configured to be connected to a load, the electric fence energiser including:
an inductive element connected to the load,
an energy storage element configured to transfer energy to the inductive
element, and
a rectifying element;
   characterised in that
the rectifying element is configured to prevent the transfer of energy from the inductive element into the load while the transfer of energy from the energy storage element to the inductive element occurs.

According to another embodiment of the present invention there is provided an electric fence energiser as described above, wherein the energy storage element is configured to store energy released by the inductive element and not absorbed by the load.

In a preferred embodiment the electric fence energiser includes a controllable switching device configured to control connection of the energy storage element to the inductive element. It is envisaged that this controllable switching device will be a thyristor, however this is not intended to be limiting and any suitable switching device known to one skilled in the art may be used—such as a triac, SiCFET or IGBT.

In a preferred embodiment, the energiser includes a controller configured to control the controllable switching device.

It is envisaged that the controller will typically be a microprocessor or microcontroller running computer code which will implement decision making algorithms. However one skilled in the art would appreciate that this is not intended to be limiting, and the controller may be analogue or digital hardware that utilises predetermined thresholds to determine the release and storage of energy. The controller may also be configured to receive information regarding electrical parameters of various aspects of the energiser, and controlling operation of the energiser accordingly.

In a preferred embodiment the energy storage element includes at least one capacitor. A person skilled in the art would appreciate that reference to the energy storage element being a capacitor is not intended to be limiting, and that other energy storage components may be implemented with the present invention, for example flywheels or Superconducting Magnetic Energy Storage (SMES) systems.

It is envisaged that the energy to be stored by the energy storage element may be provided by a charging circuit, as known in the art. The power source for the charging circuit may be battery, solar, mains power, or any other source of electrical energy. If powered by the mains then the requisite for isolation specified by safety standards may be incorporated into the charging circuit in any way known to one skilled in the art.

In a preferred embodiment, the inductive element is composed of a first inductive element and a second inductive element. It should be appreciated that this is not intended to be limiting, and that the present invention may be implemented utilising any number of inductive elements.

In a preferred embodiment, the first and second inductive elements are the primary and secondary windings of a transformer respectively. It should be appreciated that reference to the inductive elements being part of a transformer is not intended to be limiting and that the inductive elements may be any stand alone conductive component known within the art.

In a preferred embodiment, the first and second inductive elements are magnetically coupled to each other, providing electrical isolation. The first and second inductive elements may equally be separate windings of an autotransformer. This is not intended to be limiting, and the first and second inductive elements may be coupled with each other in any manner known in the art. Reference to the first and second inductive elements being coupled should be understood to refer to any way by which energy may be transferred between the two elements.

It should also be appreciated that where a single inductive element is used, the required isolation may be provided by the power supply to the energiser.

Reference to a rectifying element should be understood to mean any element which may be used to block or otherwise control the flow of current in an electric circuit. For example, a rectifying element may be a diode or a chain of diodes.

However, any suitable controllable switch, such as a SCR, triac, or an IGBT, may be used to perform the function of preventing the flow of current through the output while the energy is transferring from the energy storage element to the first inductive element.

It is envisaged that the energy threshold of the inductive element is equivalent to the amount of energy stored by the energy storage element.

However, it should be appreciated that the amount of energy stored by the energy storage element may be adjusted using a control circuit, as known in the art. In this way, the amount of energy released into the load may be restricted or controlled according to various regulatory requirements.

One skilled in the art would understand that the energy capable of being stored in an air core inductance does not have a limit per se. In this case the energy threshold is the point at which all the energy in the storage element has been transferred to the inductive element and at which point the energy stored by the inductive element is at its peak.

Reference in the specification to the energy threshold of the inductive element being equivalent to the amount of energy capable of being stored by the energy storage element is not intended to be limiting.

At the point where the energy storage element has been completely discharged, the magnetic flux stored by the first inductive element will begin to collapse and induce a voltage in the second inductive element. This causes a current to flow through the rectifying element and into the load connected to the output of the electric fence energiser. The flow of energy into the load is known as a pulse.

It should be appreciated that in the case where a second inductive element is not used, the back electromotive force (EMF) of the single inductive element will oppose a decrease in current in the inductive element when fully charged. This results in a positive voltage at the point of connection between the energy storage element, inductive element and rectifying element relative to the inductive element's connection to ground, and the rectifying element will begin to transfer energy to the load.

Where the load is indicative of an open circuit, very little energy will be absorbed. In this case, the energy will be transferred out of the inductive element(s) and back into the energy storage element, charging it in the reverse polarity. In order to return the polarity to normal, the cycle is repeated. At this point the energy storage element is disconnected from the first inductive element, storing the energy until the next discharge cycle.

Recovery of the energy previously lost allows a smaller power source to be used in the present invention for the same performance in comparison with traditional energisers. This is particularly advantageous where the energiser is not powered by a main supply, as this will allow a smaller battery or solar panel (in terms of size or power capacity) to be used. This may result in reducing the cost of the energiser, and/or replacement costs of these components during maintenance.

Further, because the saved energy is stored in the energy storage device, the resulting lower power demand on the power source per cycle to fully charge the energy storage device will improve lifetime performance of the source. This is particularly true where a battery is the power source, as the depth of discharge will be reduced—causing less stress on the battery and likely improving the service life.

It should be appreciated that the magnitude of the load on the output of the energiser will determine the amount of energy recovered and stored by the energy storage element at the end of the cycle. From this, by determining an electrical parameter such as voltage across the energy storage element after the energy has been recovered, the load provided by the electric fence may be determined.

It should be appreciated that determination of the electrical parameter may be achieved by any suitable method known to those skilled in the art. This may be implemented by way of direct input into the controller, or by way of a separate voltage determining device.

It is envisaged that a controllable switching device may be placed on the output of the energiser and operated to disconnect the inductive element from the output. It is envisaged that the energy stored by the inductive element would then return to the energy storage element.

In an alternative embodiment, energy from the power source is initially stored in an inductive energy storage element, before being transferred to a capacitive energy storage element. The inductive energy storage element and capacitive energy storage element form a resonant circuit, which in turn transfers energy to the inductive element. As the flux begins to collapse in the inductive element, energy is transferred to the fence in the manner previously described.

In a preferred embodiment the inductive element and energy storage element are selected such that the resonant frequency of the two elements together results in the desired pulse length of energy released into the load. The length of the pulse determines the amount of current transferred to the output of the energiser, which is a parameter limited by safety standard IEC 60335-2-76 and other national variants.

In particular, it is advantageous to have a pulse of which 95% of the energy contained therein occupies a time period of 100 microseconds, the RMS current of this pulse being in the order of 15.7 Amps. This is easily achievable with the present invention, and may result in pulse energies greater than achieved by previous topologies. Further, the pulse has a minimum of harmonically related frequencies, which may otherwise cause electromagnetic interference and attenuate the pulse down the length of the fence.

Some existing technologies use an additional inductor and capacitor to shape the pulse, but the additional capacitor used must have approximately the same value as the storage capacitor in order to produce an ideal pulse. This results in the effective capacitance of the circuit being twice that of the present invention. In turn, the pulse has a voltage amplitude half that of the desired amplitude. This pulse must then be transformed by a higher ratio transformer in order to achieve the desired output voltage. As the output impedance of a transformer is a function of the turns ratio squared, this results in a higher output impedance and greater losses in the transformer.

By forming the resonant circuit using the energy storage element, and using the transformer to perform the function of a separate inductor as well as that of a transformer in the present invention, the inductance required to give the correct value for the desired pulse length is typically much lower than previous topologies. This means that a transformer may use a low number of turns in a construction using the air-core winding technique.

The ability to use an air-core transformer results in much lower core losses than with traditional electric fence transformers. Further, saturation is effectively eliminated, reducing the stress on components utilised in the energiser and associated costs of maintenance or using more highly specified components. The cost of core material in a traditional electric fence energiser transformer is also eliminated.

The elimination of the additional inductor and capacitor required to form a resonant circuit in the present invention results in reduced costs, improved power efficiency (through eliminating the associated losses of the components) and a reduction in size of the required circuitry.

It should be appreciated that for the embodiments described above, the positions of the inductive element and the energy storage element may be interchanged and the principle of operation will still apply.

The present invention provides the following advantages:
Increased efficiency of the energiser and reduction in power consumption (and the associated costs) due to the recovery of energy not transferred to the electric fence;
Reduces the stress on energiser components due to power being recovered rather than dissipated in the form of heat—allowing for the use of components having lower specifications and hence lower costs. This also serves to increase the life of the components;
Increased performance and compliance with safety standards is achieved due to the pulse length being substantially constant and independent of the load;
Increased reliability and reduced costs are achieved by reducing the number of components used in comparison with traditional topologies;
The ability to power a very heavily loaded fence, as the output may be of very low impedance;
Lower losses in comparison with traditional electric fence transformers through the use of an air-core transformer for energy storage and output;
Improved efficiency over a range of output load values without the adaptive circuitry and associated software previously required. This results in a reduction in costs over those topologies while bettering the performance.

### BRIEF DESCRIPTION OF DRAWINGS

Further aspects of the present invention will become apparent from the following description which is given by way of example only and with reference to the accompanying drawings in which:

FIG. 1 shows a schematic diagram of a first circuit to be used in accordance with one embodiment of the present invention;

FIGS. 2a, 2b, 2c show graphical representations of current and voltage waveforms across various components used in accordance with one embodiment of the present invention;

FIGS. 3a, 3b, 3c show further graphical representations of current and voltage waveforms across various components used in accordance with one embodiment of the present invention;

FIG. 4 shows a schematic diagram of a circuit to be used in accordance with another embodiment of the present invention;

FIG. 5 shows a schematic diagram of a circuit to be used in accordance with another embodiment of the present invention; and

FIG. 6 shows a schematic diagram of a circuit to be used in accordance with another embodiment of the present invention.

### BEST MODES FOR CARRYING OUT THE INVENTION

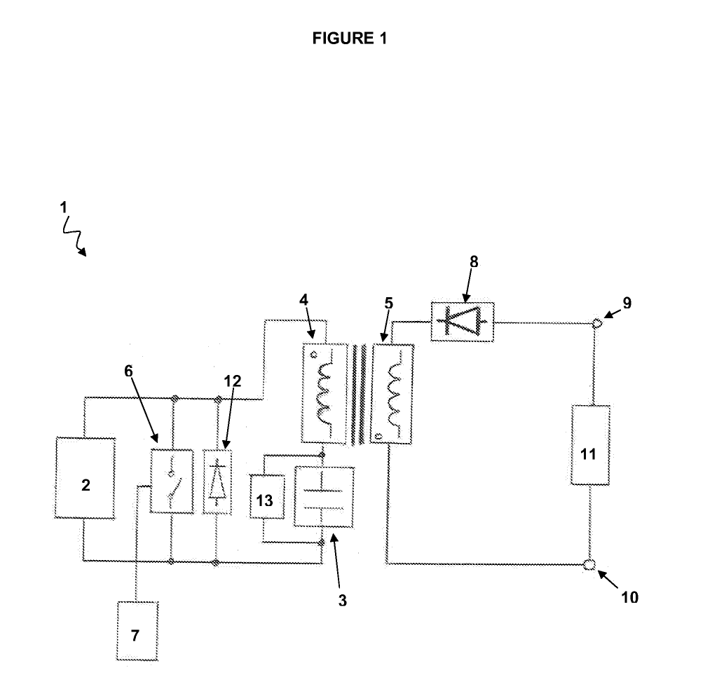

FIG. 1 is a schematic diagram of an electric fence energiser in accordance with one embodiment of the present invention.

The energiser (generally indicated by arrow 1) includes a charging circuit (2).

The charging circuit (2) may be battery, solar or mains powered. If powered by the mains then the requisite isolation specified by safety standards must be incorporated into the energiser (1) in any way known to one skilled in the art.

The energiser further includes an energy storage element provided in this embodiment by a capacitor (3).

The capacitor (3) is connected in series to a first inductive element (4).

The first inductive element (4) is magnetically coupled to a second inductive element (5). It should be appreciated that the first and second inductive elements (4 and 5) may be electrically coupled as well as magnetically coupled, i.e. in the form of an autotransformer.

The charging circuit (2) is configured to charge the capacitor (3) to a pre-selected value. This pre-selected value determines the amount of energy available to be discharged from the energiser (1). The energiser (1) includes a controllable switch (6) configured to switch the capacitor (3) to be in parallel with the first inductive element (4).

The controllable switch (6) is controlled by a control circuit (7).

In operation, the control circuit (7) turns on the controllable switch (6) which causes the capacitor (3) to transfer energy into the first inductive element (4).

While current is flowing from the capacitor (3) into the first inductive element (4) a voltage is induced across the second inductive element (5).

A rectifying element (8) is connected to the second inductive element (5). The rectifying element (8) blocks any current flow out of the second inductive element (5) caused by the induced voltage, while energy is being transferred from the capacitor (3) to the first inductive element (4).

When the capacitor (3) has been completely discharged and the current and energy stored in the first inductive element (4) has reached a maximum, there will still be no output voltage between the output terminals (9, 10), due to the current blocking effect of the rectifying element (8).

As the magnetic flux stored by the first inductive element (4) begins to collapse, a voltage in the reverse polarity will be induced in the second inductive element (5), which will cause a current to flow through the rectifying element (8), and the output load (11).

Current will also flow back into the capacitor (3), charging it in a reverse polarity to originally charged. The level of charge will be dependent on the output load (11).

When the capacitor (3) is charged to a maximum reversed polarity, the output voltage of the energiser (1) at output terminals (9, 10) will be at a maximum. The energy stored in the capacitor (3) then transfers back into the first inductive element (4) and out through the second inductive element (5) into the output load (11).

Any energy not consumed by the load (11) will be transferred out of the first inductive element (4) and back into capacitor (3), charging the capacitor (3) in a reverse polarity—especially where the load (11) is indicative of an open circuit and little energy will be absorbed.

The energy then flows from capacitor (3) through the controllable switch (6) or second rectifying element (12) and into the first inductive element (4) which again stores the remaining energy that is not transferred to the load.

The second rectifying element (12) is only required in the case where the controllable switching device (6) is a uni-direction device such as thyristor. It should be appreciated that if the controllable switching device (6) is a triac or IGBT with an inbuilt rectifier, then the second rectifying element (12) will not be required.

The energy is then transferred from the first inductive element (4) back through the controllable switching device (6) or second rectifying element (12) into the capacitor (3). At this time the controllable switching device (6) and/or second rectifying element (12) is switched off and the energy stored by the capacitor (3) is at the correct polarity, ready to be used for the next discharge cycle.

The energiser (1) also includes a voltage determining device (13) connected across the capacitor (3). The voltage determining device (13) is configured to measure the voltage across capacitor (3) at the end of the cycle. This voltage may be used to determine the value of the load (11) connected across the output (9, 10) of energiser (1).

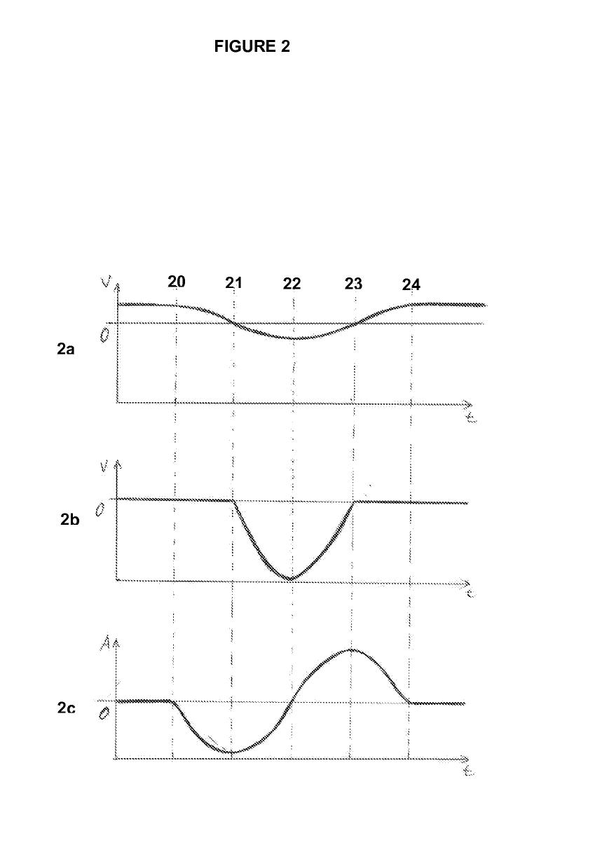

FIGS. 2a, 2b and 2c represent voltage and current waveforms across various components of energiser (1). The waveforms will be described with reference to FIG. 1.

FIG. 2a shows the voltage waveform across the capacitor (3).

FIG. 2b shows the voltage waveform at the output (9, 10) of the energiser (1).

FIG. 2c shows the current waveform through the first inductive element (4).

At point (20) the control circuit (7) switches on the controllable switching device (6) causing the capacitor (3) to transfer its stored energy into the first inductive element (4).

At point (21) the capacitor (3) has been completely discharged and the magnetic flux stored by the first inductive element (4) begins to collapse, inducing a voltage across the second inductive element (5), causing current to flow through the rectifying element (8) and load (11). The capacitor (3) is also charged in the reverse polarity.

In the event that the load (11) is indicative of an open circuit, very little energy will be absorbed, and most of the energy will flow from the first inductive element (4) and back into capacitor (3), charging it in the reverse polarity as seen between points (21 and 22).

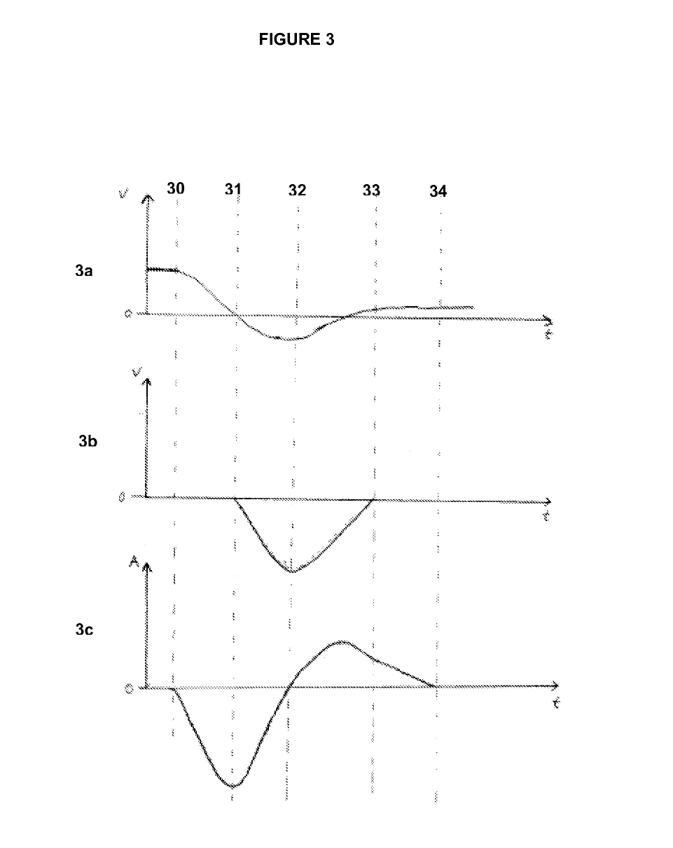

FIG. 3 shows representations of waveforms corresponding to that of FIG. 2, in a situation where the load (11) is heavier, and absorbs more energy.

In this situation, it may be seen that some of the energy is still transferred back to the capacitor (3) at the time indicated by point (32).

With reference to both FIG. 2 and FIG. 3, the energy stored in the capacitor (3) in the reverse polarity then discharges through the controllable switch (6) or second rectifying element (12) and into the first inductive element (4), and out through the second inductive element (5) to the load (11).

The output wave form across the output terminals (9, 10) may be seen in FIGS. 2b and 3b between the points marked (22 and 23) and (32 and 33) respectively.

In order to store the remaining charge in the normal polarity, the remaining energy is then transferred back from the first inductive element (4) through the controllable switching device (6) and/or the rectifying element (12) and into capacitor (3), where it is stored in the normal polarity ready for the next discharge cycle.

At this point, the controllable switching device (6) is switched off causing the capacitor (3) to store the remaining energy in preparation for the next discharge cycle.

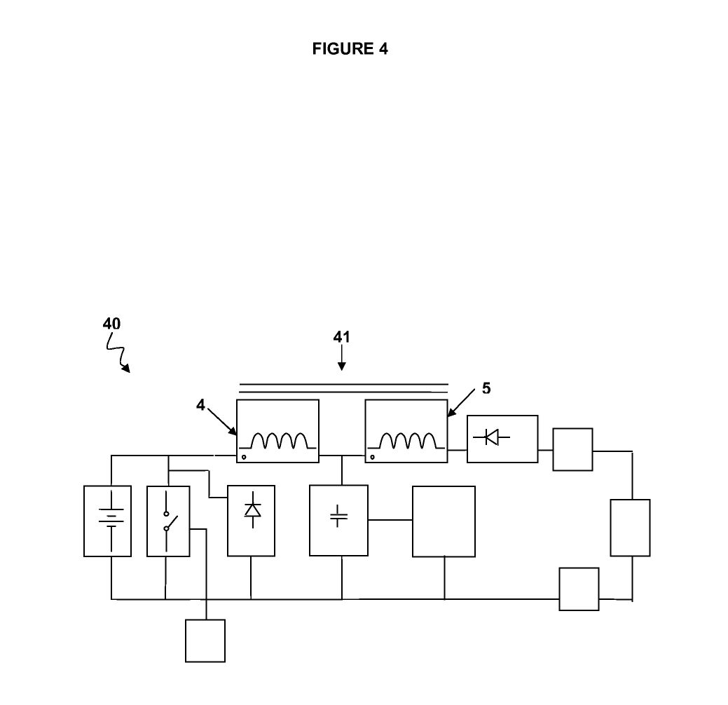

FIG. 4 is a schematic diagram of an electric fence energiser (40) in accordance with a second embodiment of the present invention.

In this embodiment, electrical isolation is not required by safety standards, for example where the power source is a battery, or where the isolation is provided by the power supply (not shown).

The energiser (40) includes a transformer (41), including the first inductive element (4) and second inductive element (5), and being wound as an autotransformer for the purpose of improving coupling, lowering winding resistance, improving efficiency and further lowering output impedance.

Otherwise, the theory of operation is as discussed with reference to FIG. 1.

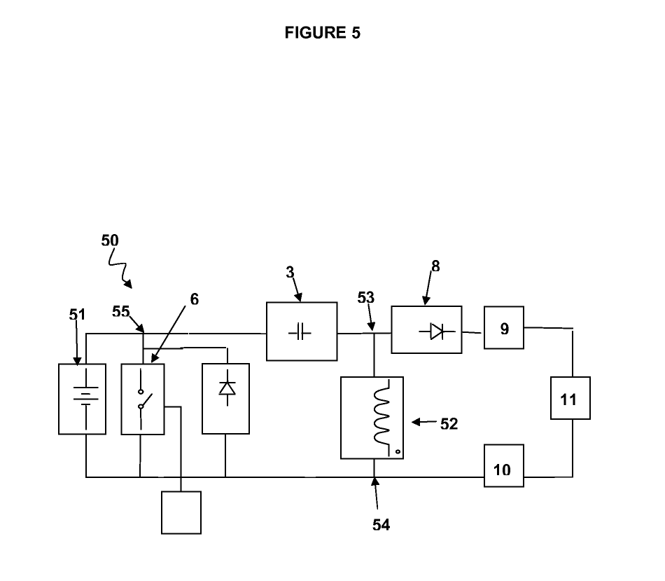

FIG. 5 is a schematic diagram of an electric fence energiser (50) in accordance with a third embodiment of the present invention.

In this embodiment, the isolation required by safety standards is incorporated into the charge circuit (51), or is not required in the case of the power source being a battery. As such, only a single inductive element (52) is required.

The charging circuit (51) is configured to charge the capacitor (3) to a pre-selected value. This pre-selected value determines the amount of energy available to be discharged from the energiser (51).

Once charged, the controllable switch (6) is closed and current flows from the capacitor (3) through the inductive element (52).

At this time a negative voltage exists at a first junction (53), and no energy flows through the rectifying element (8) to the output (9, 10).

Once the voltage across the capacitor (3) reaches zero, the inductive element (52) is storing a maximum level of energy.

A back electromotive force (EMF) is then generated across the inductive element (52), opposing a decrease in current in same. This results in a positive voltage at the first junction (53) in relation to a second junction (54), and the rectifying element (8) begins to transfer energy to the load (11).

Simultaneously, the capacitor (3) is charged to a reverse polarity on a third junction (55) with respect to the first junction (53). When the voltage on the capacitor (3) reaches a maximum it again discharges out through the rectifying element (8), through the load (11) and into the inductive element (52).

Any energy not consumed by the load (11) is then transferred from the inductive element (52) to the capacitor (3). The voltage stored by the capacitor (3) at this point may be measured to indicate the value of the load (11).

The discharge cycle then repeats.

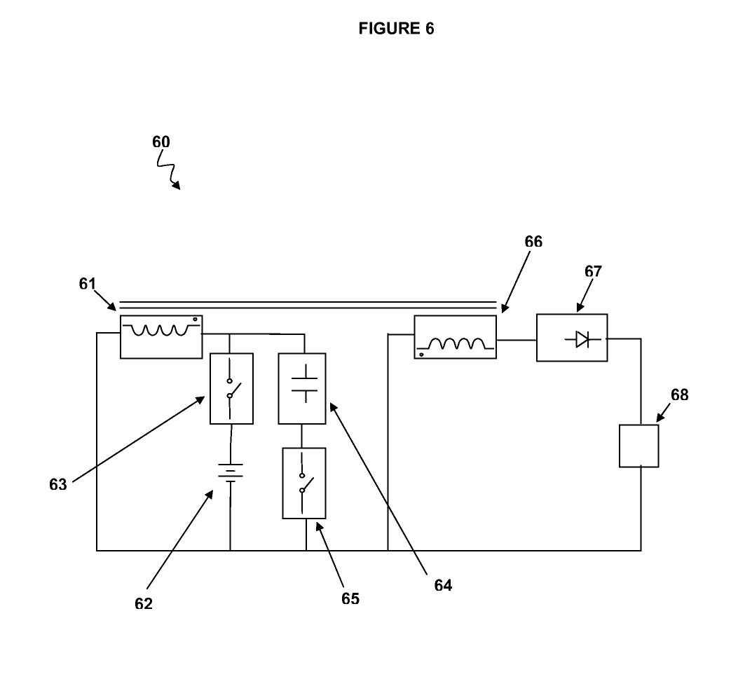

FIG. 6 is a schematic diagram of an electric fence energiser (60) in accordance with a fourth embodiment of the present invention.

In this embodiment, the energiser (60) includes an inductive energy storage element (61).

The inductive energy storage element (61) is connected to a charging circuit (62) by way of a first controllable switch (63). The inductive energy storage element (61) is also connected to a capacitive energy storage element (64), in turn connected to a second controllable switch (65).

In operation, the second controllable switch (65) is opened, and the first controllable switch (63) is closed. Energy is transferred from the charging circuit (62) to the inductive energy storage element (61).

Once charged to a predetermined energy level, the first controllable switch (63) is opened, and the second controllable switch (65) is closed.

The inductive energy storage element (61) and capacitive energy storage element (64) form a resonant circuit, passing energy through a first inductive element (66) and rectifying element (67) into the load (68) in the manner previously described.

Aspects of the present invention have been described by way of example only and it should be appreciated that modifications and additions may be made thereto without departing from the scope thereof as defined in the appended claims.

1. A method of operating an electric fence energiser having an output configured to be connected to a load, comprising the steps of:
storing energy in an energy storage element;
transferring energy from the energy storage element to an inductive element;
using a rectifying element to prevent the transfer of energy from the inductive element into the load on the output of the energiser while the transfer of energy from the energy storage element to the inductive element occurs, and
releasing the energy held by the inductive element once an energy threshold on the inductive element has been reached.

2. A method as claimed in claim 1, further comprising the step of:
storing the energy released by the inductive element and not absorbed by the load in the energy storage element.

3. A method as claimed in claim 1, further comprising the step of using a controllable switching device to control the transfer of energy from the energy storage element to the inductive element.

4. A method as claimed in claim 1, further comprising the step of selecting the inductive element and energy storage element such that the resonant frequency of the two elements together results in a desired pulse length of energy released into the load.

5. A method as claimed in claim 1, wherein storing the energy in the energy storage element comprises initially storing the energy in an inductive energy storage element, and subsequently transferring the energy to the energy storage element.

6. An electric fence energiser having an output configured to be connected to a load, the electric fence energiser comprising:
an inductive element connected to the load,
an energy storage element configured to transfer energy to the inductive element, and
a rectifying element,
wherein the rectifying element is configured to prevent the transfer of energy from the inductive element into the load while transfer of energy from the energy storage element to the inductive element occurs.

7. An electric fence energiser as claimed in claim 6 wherein the energy storage element is configured to store energy released by the inductive element and not absorbed by the load.

8. An electric fence energiser as claimed in claim 6, wherein the energy storage element comprises at least one capacitor.

9. An electric fence energiser as claimed in claim 6, comprising a controllable switching device configured to control connection of the energy storage element to the inductive element.

10. An electric fence energiser as claimed in claim 9 wherein the controllable switching device comprises a thyristor.

11. An electric fence energiser as claimed in claim 6, wherein the inductive element comprises a first inductive element and a second inductive element.

12. An electric fence energiser as claimed in claim 11, wherein the first inductive element is magnetically coupled to the second inductive element.

13. An electric fence energiser as claimed in claim 11, wherein the first inductive element is electrically coupled to the second inductive element.

14. An electric fence energiser as claimed in claim 11, wherein the inductive element is a transformer, the first inductive element is a primary winding of the transformer, and the second inductive element is a secondary winding of the transformer.

15. An electric fence energiser as claimed in claim 14, wherein the transformer is an air-core transformer.

16. An electric fence energiser as claimed in claim 6, comprising an inductive energy storage element configured to store energy supplied by a power source, and subsequently transfer the energy to the energy storage element.

17. An electric fence energiser as claimed in claim 6, comprising an output controllable switching device configured to control connection of the energiser to the load.

18. An electric fence energiser as claimed in claim 6, wherein the inductive element and energy storage element are selected such that the resonant frequency of the two elements together results in a desired pulse length of energy released into the load.

19-20. (canceled)
